(19) United States
(12) Patent Application Publication
(10) Pub. No.: US 2014/0201687 A1
(43) Pub. Date: Jul. 17, 2014

(54) INFORMATION PROCESSING APPARATUS AND METHOD OF CONTROLLING INFORMATION PROCESSING APPARATUS

(71) Applicant: FUJITSU LIMITED, Kawasaki-shi (JP)

(72) Inventor: Koki Hatada, Kawasaki (JP)

(73) Assignee: FUJITSU LIMITED, Kawasaki-shi (JP)

(21) Appl. No.: 14/133,908

(22) Filed: Dec. 19, 2013

(30) Foreign Application Priority Data
Jan. 15, 2013 (JP) 2013-004446

(51) Int. Cl. G06F 3/0484

(52) U.S. Cl. CPC G06F 3/0484
USPC 715/857

(57) ABSTRACT

An information processing apparatus capable to be coupled to a display device with a display screen includes a memory, and a processor coupled to the memory and configured to acquire a position of a pointer displayed on the display screen, the pointer indicating operation position by a user of the information processing apparatus, and change a view mode of an operation object displayed on the display screen based on a transition in a position of the displayed pointer, the operation object being to be operated by the pointer.

### CROSS-REFERENCE TO RELATED APPLICATION

This application is based upon and claims the benefit of priority of the prior Japanese Patent Application No. 2013-004446, filed on Jan. 15, 2013, the entire contents of which are incorporated herein by reference.

### FIELD

The embodiment discussed herein is related to an information processing apparatus and a method of controlling an information processing apparatus.

### BACKGROUND

As a user interface that allows the user to perform operations at locations apart from the screen, spatial gesture technology in which on-screen operations are performed by the user's body and hand gestures is known.

In spatial gesture technology, intuitiveness higher than that in the case of using a mouse and a keyboard is able to be attained by moving a cursor in a direction in which a hand is moved, for example.

Japanese Laid-open Patent Publication No. 2011-170866, Japanese Laid-open Patent Publication No. 2004-341892, and Japanese Laid-open Patent Publication No. 2006-157379 disclose the related art.

### SUMMARY

According to an aspect of the invention, an information processing apparatus capable to be coupled to a display device with a display screen includes a memory, and a processor coupled to the memory and configured to acquire a position of a pointer displayed on the display screen, the pointer indicating operation position by a user of the information processing apparatus, and change a view mode of an operation object displayed on the display screen based on a transition in a position of the displayed pointer, the operation object being to be operated by the pointer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the hardware configuration of a display control system according to an exemplary embodiment;

FIG. 2 is an illustration for explaining conditions for a determination of the presence or absence of an intention to operate the widget in the display control system according to the exemplary embodiment;

FIG. 3 is a flowchart illustrating a display control process in the display control system according to the exemplary embodiment;

FIG. 4 is an illustration for explaining an approach of calculating conditions for a determination of the presence or absence of an intention to operate the widget in a display control system according to a fourth modification of the embodiment;

FIG. 5A is an illustration for explaining effects regarding each modification of the display control system of the embodiment; and

FIG. 5B is a graph for explaining effects regarding each modification of the display control system of the embodiment.

### DESCRIPTION OF EMBODIMENT

The resolutions in spatial gesture technology are, in general, low, and therefore it is difficult to move a pointer in a small area on a screen, for example. That is, spatial gesture technology has a problem in that it is tough to perform fine operations on the screen.

In one aspect, it is an object of the present disclosure to perform efficient screen display control.

In addition, the present disclosure is not limited to the above object, and another object of the present disclosure is to attain operation effects that are derived from the configurations indicated in an embodiment described below and that are not obtained by conventional technology.

Hereinafter, an embodiment of a display control device, a display control system, and a display control method according to the present disclosure will be described with reference to the drawings. However, the embodiment described below is only illustrative, and there is no intention to exclude various modifications and technical applications that are not explicitly described in the embodiment. That is, this embodiment may be carried out in various modified forms (such as combinations of the embodiment with modifications) without departing from the spirit and scope thereof.

Each drawing is not intended to include only elements illustrated in the drawing and may include other functions and so forth.

[A] Exemplary Embodiment

[A-1] Hardware Configuration

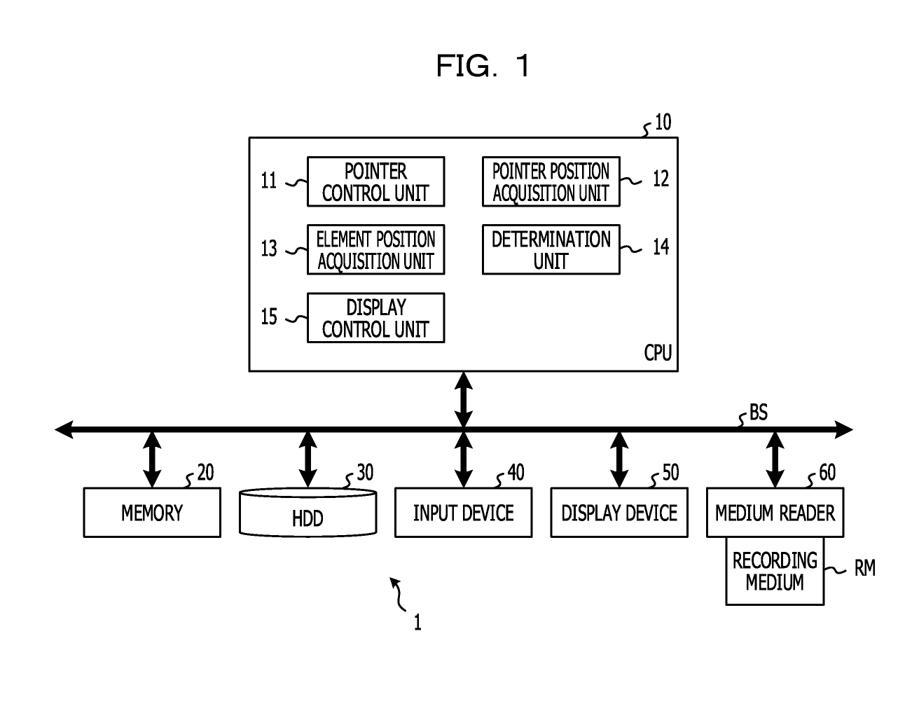

FIG. 1 is a block diagram illustrating the hardware configuration of a display control system according to an exemplary embodiment.

As illustrated in FIG. 1, a display control system 1 includes a central processing unit (CPU; display control device) 10, a memory (position information storage unit) 20, a hard disk drive (HDD) 30, an input device 40, a display device 50, and a medium reader 60.

These CPU 10, memory 20, HDD 30, input device 40, display device 50, and medium reader 60 are connected through a bus line BS, for example, so as to be capable of communicating.

The memory 20 is a storage device including a read only memory (ROM) and a random access memory (RAM). An operating system (OS), a software program related to display control (display control program), and data and the like for this program are written in the ROM of the memory 20. The software program stored in the memory 20 is appropriately read into the CPU 10 and is executed. The RAM of the memory 20 is used as a primary record memory or a working memory. In this exemplary embodiment, the memory 20 stores coordinates p (x, y) of a pointer PT on the display screen of the display device 50 acquired by a pointer position acquisition unit 12 described below.

The HDD 30 is a storage device that stores various data and programs for various controls and operations to be performed by the CPU 10, and that stores results of operations performed by the CPU 10.

The input device 40 detects various kinds of input operations performed by the operator. The operator moves the pointer PT displayed on the display device 50 by moving his or her body such as a hand (a determination object) toward the input device 40. The input device 40 has a function of detecting the motion of the determination object, and is a combination of a distance sensor, a simple eye camera or a stereo camera, and an object tracking device, which is a device that processes information read by the distance sensor and the simple eye camera or stereo camera. The input device 40 may be a gyroscope sensor, an acceleration sensor, or a terminal capable of performing position acquisition using ultrasonic waves, for example, and may be carried out in various modified forms.

The display device 50 is a liquid crystal display, a cathode ray tube (CRT), a projector, or a head mounted display (HMD), for example, and displays a variety of information for the operator and the like.

The medium reader 60 is configured so that a recording medium RM is insertable. The medium reader 60 is configured so as to be capable of reading information recorded on the recording medium RM under the condition where the recording medium RM is inserted in the medium reader 60. In this example, the recording medium RM has portability. The recording medium RM is a computer-readable recording medium, and is a flexible disk, a compact disc (CD) (such as a CD-ROM, a CD-recordable (R), or a CD-rewritable (RW)), a digital video disc (DVD) (such as a DVD-ROM, a DVD-RAM, a DVD-R, a DVD+R, a DVD-RW, a DVD+RW, or an HD DVD), a blu-ray disc, a magnetic disk, an optical disc, a magneto-optical disc, or a semiconductor memory, for example.

The CPU 10 is a processing unit that performs various controls and operations, and implements various functions by executing the OS and the program stored in the memory 20. That is, the CPU 10 functions as a pointer control unit 11, a pointer position acquisition unit 12, an element position acquisition unit 13, a determination unit 14, and a display control unit 15, as illustrated in FIG. 1.

Then, the CPU 10 of the display control system 1 executes the display control program, thereby functioning as the pointer control unit 11, the pointer position acquisition unit 12, the element position acquisition unit 13, the determination unit 14, and the display control unit 15.

Note that the program (the display control program) for implementing functions of the pointer control unit 11, the pointer position acquisition unit 12, the element position acquisition unit 13, the determination unit 14, and the display control unit 15 is provided in the form recorded on the recording medium RM mentioned above, for example. Then, the computer reads the program from the recording medium RM, and transfers the program to an internal storage device or an external storage device, and stores and uses the program therein. Alternatively, the program may be recorded, for example, on a storage device (recording medium), such as a magnetic disc, an optical disc, or a magneto-optical disc, and be provided from the recording device through a communication path to the computer.

At the time of implementing the functions of the pointer control unit 11, the pointer position acquisition unit 12, the element position acquisition unit 13, the determination unit 14, and the display control unit 15, the program stored in the internal storage (the memory 20 in this embodiment) is executed by the microprocessor (the CPU 10 in this embodiment) of the computer. At this point, the computer may read and execute the program recorded on the recording medium.

Note that, in this embodiment, the term computer is a concept including hardware and the OS and refers to hardware that operates under control of the OS. In the case where the OS is unnecessary and the hardware is operated by an application program alone, the hardware itself corresponds to the computer. The hardware includes at least a microprocessor, such as a CPU, and a measure for reading a computer program recorded on a recording medium. In this embodiment, the display control system 1 has the function of a computer.

The pointer control unit 11 acquires the position of the operator's hand, and controls the display position of the pointer PT. In particular, the pointer control unit 11 acquires a motion of the operator's hand detected by the input device 40, and controls the display position of the pointer PT on the display screen of the display device 50 in accordance with the position and motion of the hand. Here, the coordinate system of the operator's hand is determined such that the normal direction of the screen of the display device 50 is the z-axis, and the direction of moving away from the screen is positive. Additionally, the horizontal direction in the plane of the screen is determined as the x-axis (the right direction is positive), and the vertical direction is determined as the y-axis (the downward direction is positive). On the basis of the coordinate system set in this way, the pointer control unit 11 acquires coordinates H (xₕ, yₕ, zₕ) of the operator's hand. Then, the pointer control unit 11 calculates the coordinates p (x, y) of the pointer PT on the screen on the basis of the coordinates H of the acquired hand. Here, the coordinate system of the pointer PT is determined such that the horizontal direction in the plane of the screen is the x-axis (the right direction is positive), and the vertical direction is the y-axis (the downward direction is positive). The expressions for calculating the coordinates p of the pointer PT from the coordinates H of the hand are given, for example, by

x=aₓxₕ+bₓ, y=a_{y}yₕ+b_{y}

where aₓ, bₓ, a_{y}, and b_{y} are each constant real numbers, and are values arbitrarily determined from the resolution of the screen and so forth.

The pointer position acquisition unit 12 acquires the coordinates p of the pointer PT calculated by the pointer control unit 11. The pointer position acquisition unit 12 stores the coordinates p of the acquired pointer PT as position information in the memory 20.

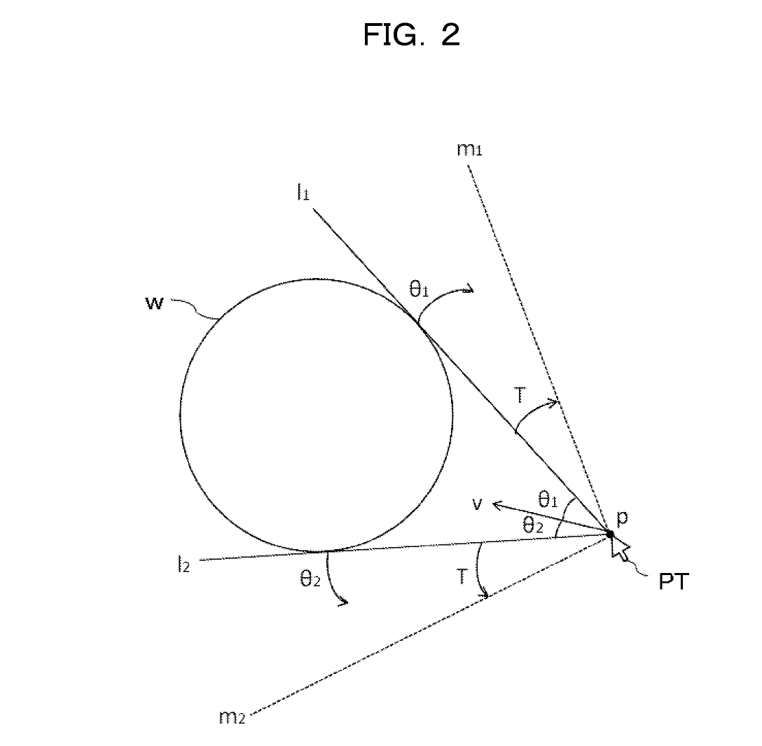

The element position acquisition unit 13 acquires the position of a widget w (operation object element) (for example, refer to FIG. 2) on the display screen of the display device 50. The element position acquisition unit 13 is able to acquire the position of the widget w, for example, by acquiring the coordinates at which the widget w is positioned. The coordinates of the widget w are acquirable from programs, such as the OS and programs, that perform control for displaying the widget w concerned on a display screen, for example.

On the basis of the position transition of the pointer PT the determination unit 14 determines the presence or absence of the operator's intention to operate the widget w. Here, the position transition refers to changes in the position, speed, and movement direction of the pointer PT on the display screen. That is, the determination unit 14 acquires the position information acquired by the pointer position acquisition unit 12 and stored in the memory 20, thereby acquiring changes in the position, speed, and movement direction of the pointer PT on the display screen as position transition information. Then, the determination unit 14 compares the position transition information with the position of the widget w acquired by the element position acquisition unit 13, and determines the presence or absence of the operator's intention to operate the widget w. A specific method for an operation intention determination performed by the determination unit 14 will be described below.

The display control unit 15 changes the display of the widget w on the display screen of the display device 50. In particular, on the basis of the result of the determination by the determination unit 14 of whether the operator's intention to operate the widget w on the display screen of the display device 50 is present or absent, the display control unit 15 changes the widget w on the display screen of the display device 50 so as to cause the widget w to be in view or hidden from view. That is, if the determination unit 14 determines that the intention to operate the widget w is absent, the display control unit 15 hides the widget w from view on the display screen. If the determination unit 14 determines that the intention to operate the widget w is present, the display control unit 15 causes the widget w to be in view on the display screen.

[A-2] Method for Determining Operation Intention

FIG. 2 is an illustration for explaining conditions for a determination of the presence or absence of an intention to operate the widget in the display control system according to the exemplary embodiment.

In the example illustrated in FIG. 2, the pointer PT and the circular widget w are displayed on the display screen. Note that it is assumed that the pointer PT is positioned at the point p.

Assuming that the point p is the starting point, the pointer PT moves at a speed v in the direction of a vector v illustrated in FIG. 2. It is assumed that tangents (reference lines) I₁ and I₂ are drawn from the point p to the widget w. It is further assumed that the angle between the vector v and the tangent I₁ is θ₁, and the angle between the vector v and the tangent I₂ is θ₂. It is still further assumed that, a broken line m₁ having an angle of a threshold T with respect to the tangent I₁ is drawn on the opposite side of the widget w with respect to the tangent I₁, and a broken line m₂ having an angle of the threshold T with respect to the tangent I₂ is drawn on the opposite side of the widget w with respect to the tangent I₂.

The determination unit 14 determines whether the magnitude (speed) |v| of a speed vector v is greater than a speed V defined as a threshold in advance. If the speed |v| of the pointer PT is small, the pointer PT is likely to be affected by shaking of the operator's hand and so on, and noise has to be disregarded. Accordingly, if the speed |v| of the pointer PT is less than the threshold V, the determination unit 14 determines that the intention to operate the widget w is present. That is, if the speed |v| is less than the threshold V, the determination unit 14 determines that the intention to operate the widget w is present even if the pointer PT moves in any direction. If the speed |v| is equal to or greater than the threshold V, the determination unit 14 determines that the intention to operate the widget w is present only in the case where the pointer PT moves toward the widget w.

If the speed |v| is equal to or greater than the threshold V, the determination unit 14 further determines whether a ray drawn in the direction of the vector v from the point p intersects the widget w.

If the ray drawn in the direction of the vector v from the point p intersects the widget w, the determination unit 14 determines that the intention to operate the widget w is present. That is, the display control unit 15 maintains the display of the widget w.

If the ray drawn in the direction of the vector v from the point p does not intersect the widget w, the determination unit 14 further determines whether the angle θ₁ or θ₂ is smaller than the threshold T. That is, under the condition where the threshold T serves as a margin, the determination unit 14 determines whether the pointer PT moves toward the widget w.

If the angle θ₁ or θ₂ is smaller than the threshold T, the determination unit 14 determines that the intention to operate the widget w is present. That is, the display control unit 15 maintains the display of the widget w.

Otherwise, if the angle θ₁ and θ₂ are equal to or larger than the threshold T, the determination unit 14 determines that the intention to operate the widget w is absent. That is, the display control unit 15 hides the widget w from view.

That is, if the situation corresponds to at least one of determinations (1) to (3) mentioned below, the determination unit 14 determines that the intention to operate the widget w is present.

(1) The speed |v| is less than the threshold V.

(2) The ray drawn in the direction of the vector v from the point p intersects the widget w.

(3) The angle θ₁ or θ₂ is smaller than the threshold T.

In contrast, if the situation does not correspond to any of the above determinations (1) to (3), the determination unit 14 determines that the intention to operate the widget w is absent.

[A-3] Display Control Process

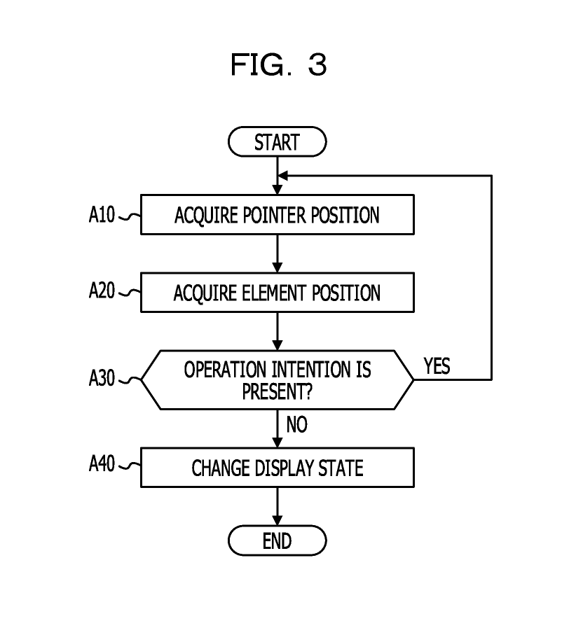

FIG. 3 is a flowchart illustrating a display control process in the display control system according to the exemplary embodiment.

The display control process in the display control system 1 according to the exemplary embodiment configured as described above will be described in accordance with the flowchart (steps A10 to A40) illustrated in FIG. 3.

The pointer position acquisition unit 12 acquires the coordinates p of the pointer PT calculated by the pointer control unit 11 (step A10). The pointer position acquisition unit 12 stores the acquired coordinates p of the pointer PT as position information in the memory 20.

The element position acquisition unit 13 acquires the position of the widget (operation object element) w on the display screen of the display device 50 (step A20).

Using the method for determining an operation intention mentioned above, the determination unit 14 determines whether there is an intention to operate the widget w (step A30).

If the intention to operate the widget w is absent (refer to the NO route at step A30), the display control unit 15 hides the widget w from view on the display screen (step A40), and ends the display control process.

Otherwise, if the intention to operate the widget w is present (refer to the YES route at step A30), the process returns to step A10.

[A-4] Effects

In this way, in the display control system 1 according to the exemplary embodiment, the determination unit 14 may determine whether there is an intention to operate the widget w by acquiring changes in the position, speed, and movement direction of the pointer PT, as position transition information.

Then, since the display control unit 15 hides the widget w from view if the determination unit 14 determines that the intention to operate the widget w is absent, the operator may perform operations efficiently.

Additionally, even if a plurality of widgets w are provided on the screen, the determination unit 14 acquires changes in the position, speed, and the movement direction of the pointer PT as position change information, and compares the changes with the position of each widget w, so that the display control unit 15 may appropriately change each widget w so as to cause the widget w to be in view or hidden from view.

[B] Modifications

The technology of this disclosure is not limited to the embodiment described above, and may be carried out in various modified forms in the scope without departing from the spirit of this embodiment. Each configuration and each processing of this embodiment may be accepted or rejected in accordance with the necessity, or may be combined appropriately.

[B-1] First Modification

In a first modification of this embodiment, in addition to the determination conditions for the widget w in the display control system 1 according to the exemplary embodiment described above, the speed of the pointer PT in a component direction perpendicular to the direction from the pointer PT to the widget w is also included in the determination conditions.

Specifically, in the state where the widget w is displayed in the negative direction of the y-axis (above) and if the pointer PT moves fast in the x-axis direction (the horizontal direction), the determination unit 14 determines that the intention to operate the widget w is absent.

The determination unit 14 determines whether the x component |vₓ | of the speed |v| of the pointer PT is greater than a speed K, which is arbitrarily defined as a threshold.

If the x component |vₓ| of the speed |v| of the pointer PT is greater than the speed K arbitrarily defined as a threshold, the determination unit 14 determines that the intention to operate the widget w is absent. Then, the display control unit 15 hides the widget w from view.

Otherwise, if the x component |vₓ| of the speed |v| of the pointer PT is not greater than the speed K arbitrarily defined as a threshold, the determination unit 14 determines that the intention to operate the widget w is present. Then, the display control unit 15 maintains the display of the widget w.

That is, when the pointer PT moves fast in the component direction perpendicular to the direction from the pointer PT to the widget w, the determination unit 14 determines that the intention to operate the widget w is absent.

In this way, with the display control system 1 according to the first modification of the embodiment, the same operation effects as in the exemplary embodiment described above may be obtained, and also the effect mentioned below may be attained.

The determination unit 14 uses, as a determination condition, the speed of the pointer PT in the component direction perpendicular to the direction from the pointer PT to the widget w. Thereby, the display control unit 15 may change the widget w more finely so as to cause the widget w to be in view or hidden from view.

[B-2] Second Modification

In a second modification of this embodiment, in addition to the determination conditions for the widget w in the display control system 1 according to the exemplary embodiment described above, the distance between the widget w and the coordinates p of the pointer PT is included in the determination conditions.

If the intention to operate the widget w is present, the pointer PT is estimated to move linearly from an initial position p₀ in a direction toward the widget w. Accordingly, the determination unit 14 determines the operation intention on the basis of a motion of the pointer PT after display of the widget w.

Here, the initial position of the pointer PT is denoted by p₀, and the Euclidean distance between the coordinates p and the widget w is denoted by d (p, w). Note that the initial position of the pointer PT is the position of the pointer at the moment of display of the widget w.

The determination unit 14 calculates, as a determination condition,

d (p, w)+d (p, p₀)<D (1), where D is a constant arbitrarily set on the basis of the size of the widget w. Note that a weight may be assigned to each of d (p, w) and d (p, p₀). Additionally, although the determination conditions are defined using the Euclidean distance in the above expression (1), the determination conditions may be defined using the Manhattan distance, for example.

If the above expression (1) holds, the determination unit 14 determines that the intention to operate the widget w is present. Then, the display control unit 15 maintains the display of the widget w.

In contrast, if the above expression (1) does not hold, the determination unit 14 determines that the intention to operate the widget w is absent. Then, the display control unit 15 hides the widget w from view.

That is, when the intention to operate the widget w is present, the determination unit 14 carries out the determination on the basis of the assumption that the pointer PT is to move linearly from the initial position p₀ in a direction toward the widget w. Consequently, if the pointer PT moves so that the distances from both the initial position p₀ and the widget w increase, the determination unit 14 determines that the intention to operate the widget w is absent.

In this way, with the display control system 1 according to the second modification of the embodiment, the same operation effects as in the exemplary embodiment described above may be obtained, and also the effect mentioned below may be attained.

The determination unit 14 uses, as a determination condition, the distance between the widget w and the coordinates p of the pointer PT. This enables the display control unit 15 to change the widget w more finely so as to cause the widget w to be in view or hidden from view.

[B-3] Third Modification

In a third modification of this embodiment, in addition to the determination conditions for the widget w in the display control system 1 according to the exemplary embodiment described above, a specific region S is set in advance for the widget w, and whether the pointer PT is inside the region S is also included in the determination conditions.

Here, the region S is defined so as to include the initial position of the pointer PT and the widget w.

The determination unit 14 determines whether the pointer PT is inside the region S.

If the pointer PT is inside the region S, the determination unit 14 determines that the intention to operate the widget w is present. Then, the display control unit 15 maintains the display of the widget w.

In contrast, if the pointer PT is not inside the region S, the determination unit 14 determines that the intention to operate the widget w is absent. Then, the display control unit 15 hides the widget w from view.

Note that, in the third modification, the operation intention determination performed by the determination unit 14 is carried out at regular time intervals (for example, every 1/30 seconds, every 1/60 seconds) after the widget w is displayed.

In this way, with the display control system 1 according to the third modification of the embodiment, the same operation effects as in the exemplary embodiment described above may be obtained, and also the effect mentioned below may be attained.

The determination unit 14 sets the specific region S in advance for the widget w, and uses, as a determination condition, whether the pointer PT is inside the region S. This enables the display control unit 15 to change the widget w more finely so as to cause the widget w to be in view or hidden from view.

[B-4] Fourth Modification

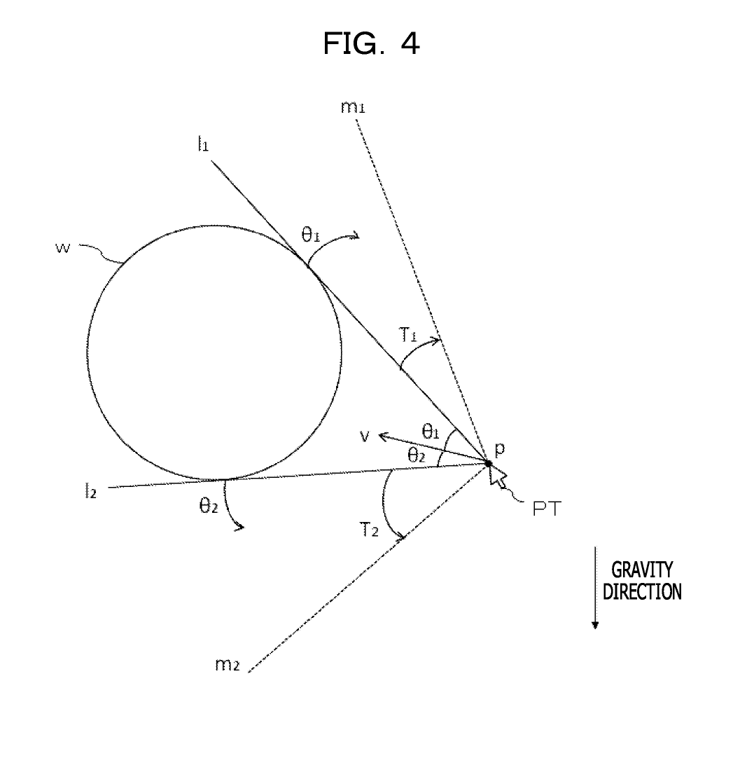

FIG. 4 is an illustration for explaining an approach of calculating determination conditions for a widget in a display control system according to the fourth modification of the embodiment.

In the fourth modification of this embodiment, in addition to the determination conditions for the widget w in the display control system 1 according to the exemplary embodiment described above, the movement in the gravity direction (positive direction of the y-axis) of the pointer PT is also included in the determination conditions.

In the exemplary embodiment described above, in the case where the widget w is positioned above the pointer PT, if the pointer PT moves in the positive direction of the Y-axis (downward direction), the determination unit 14 determines that the intention to operate the widget w is absent.

However, the case where the operator feels fatigued and lowers his or her hand is conceivable. There is the possibility that, in reality, the intention to operate the widget w is present.

Accordingly, in the fourth modification, instead of the threshold T used as the margin in the approach of calculating determination conditions for the widget w illustrated in FIG. 2, thresholds T₁ and T₂ are used as illustrated in FIG. 4. Additionally, it is assumed that the straight line I₁ is in the negative direction of the y-axis (upward direction) more than the straight line I₂.

Here, the threshold T₁<the threshold T₂, and the threshold T₂ used as the margin in the gravity direction, which is downward in the drawing, is made greater than the threshold T₁.

Note that the other determination conditions are the same as the determination conditions in the exemplary embodiment described above, and the values and explanations for marks other than the thresholds T₁ and T₂ illustrated in FIG. 4 will not be further described.

In this way, with the display control system 1 according to the fourth modification of the embodiment, the same operation effects as in the exemplary embodiment described above may be obtained, and also the effect mentioned below may be attained.

The determination unit 14 uses, as a determination condition, the movement in the gravity direction (positive direction of the y-axis) of the pointer PT. This enables the display control unit 15 to maintain the display of the widget w even if the operator lowers his or her hand in the gravity direction because of the fatigue and so on.

[B-5] Fifth Modification

In the display control system 1 according to the exemplary embodiment described above, if the determination unit 14 determines that the intention to operate the widget w is absent, the display control unit 15 hides the widget w from view.

In contrast, in a fifth modification, if the determination unit 14 determines that the intention to operate the widget w is absent, the display control unit 15 gradually changes the display of the widget w.

Using various methods for determining an operation intention described above, the determination unit 14 determines whether there is an intention to operate the widget w. Note that the operation intention determination performed by the determination unit 14 is repeatedly carried out at regular time intervals.

If the determination unit 14 determines that the intention to operate the widget w is absent, the display control unit 15 increases the transparency of the widget w by an amount determined in advance.

Determining the operation intention by the determination unit 14 and increasing the transparency of the widget w by the display control unit 15 are repeatedly performed until the transparency of the widget w is maximized.

Note that changing the display of the widget w by the display control unit 15 is not limited to the increase in transparency. For example, the size of the widget w may be reduced, and the brightness may be increased.

In this way, with the display control system 1 according to the fifth modification of the embodiment, the same operation effects as in the exemplary embodiment described above may be obtained, and also the effect mentioned below may be attained.

The display control unit 15 gradually changes the display of the widget w. Thereby, the operator may recognize that the widget w becomes hidden from view, and perform operations efficiently.

[B-6] Others

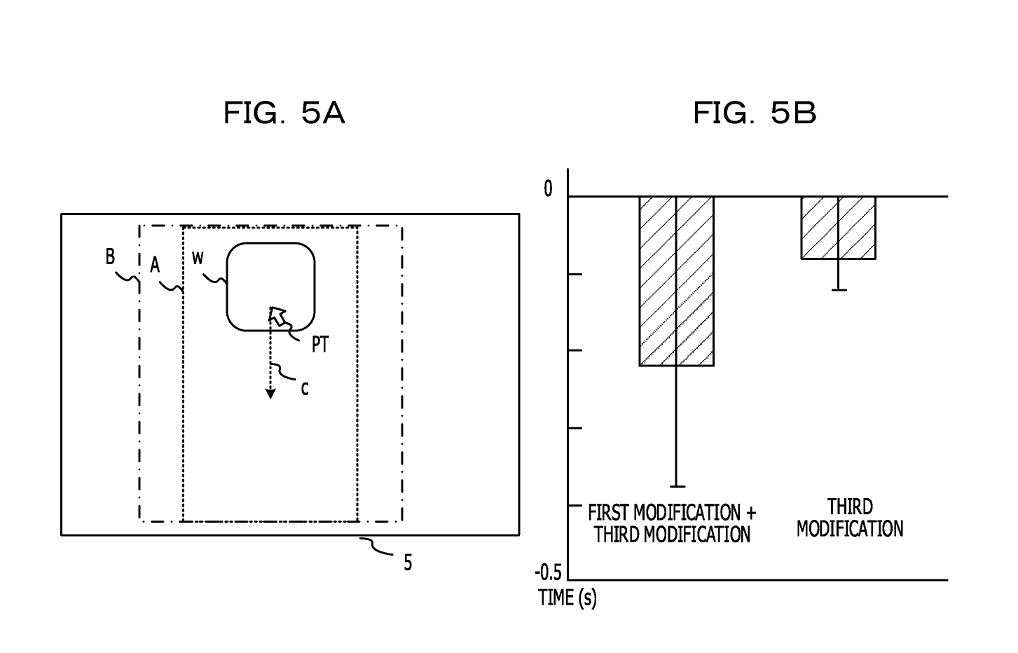

FIG. 5A illustrates a display screen for explaining effects regarding each modification of the display control system of the embodiment.

As illustrated in FIG. 5A, the pointer PT and the widget w are displayed on a display screen 5.

After the pointer PT has entered the area of the widget w, the operator moves the pointer PT in a specific direction (in the example illustrated in FIG. 5A, the positive direction of the y-axis as indicated by an arrow c), thereby making it possible to select the widget w without clicking it. The pointer PT draws a specific locus, so that the widget w is displayed above the pointer PT (in the negative direction of the y-axis) at any time.

As the region S mentioned above in the third modification, as illustrated in FIG. 5A, a region A and a region B are set such that the lengths in the horizontal direction in the drawing (the x-axis direction) of the region A and the region B are about twice and about four times that of the widget w, respectively. Note that the region A and the region B are set in such a manner as to have the same length in the vertical direction in the drawing (the y-axis direction), so that the pointer PT and the widget w are sufficiently included therein at the moment of displaying the widget w.

Here, the determination conditions for the widget w indicated in (1) to (3) mentioned below are set, and an experiment for measuring a time from selection of the widget w until the widget w is hidden from view is carried out under each of the determination conditions. Note that the number of samples of this experiment is 53.

(1) The determination conditions of the first modification+the third modification (the region A is set as the region S).

(2) The determination conditions of the third modification (the region A is set as the region S).

(3) The determination conditions of the third modification (the region B is set as the region S).

Among the experiments under the above determination conditions (1) to (3), the experiment under the determination condition (3), where the region B is set as the region S, takes the longest time until the widget w is hidden from view.

Accordingly, the average and standard deviation of times (reductions of time) by which times taken until the hiding are reduced in the experiments under each of the determination conditions (1) and (2) from those in the experiment under the determination condition (3) are illustrated in FIG. 5B.

As illustrated in FIG. 5B, the average of reductions of time under the determination condition (1) is more than twice that under the determination condition (2).

In this way, when both the determination condition of the first modification and the determination condition of the third modification are set, efficient screen display control may be performed as compared with the case where only the determination condition of the third modification is set.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus capable to be coupled to a display device with a display screen, comprising:
a memory; and
a processor coupled to the memory and configured to:
acquire a position of a pointer displayed on the display screen, the pointer indicating operation position by a user of the information processing apparatus, and
change a view mode of an operation object displayed on the display screen based on a transition in a position of the displayed pointer, the operation object being to be operated by the pointer.

2. The information processing apparatus according to claim 1, wherein
the processor is configured to change the view mode to hide the operation object from the display screen when a movement direction of the pointer is outside a range defined based on a position of the operation object relative to the pointer.

3. The information processing apparatus according to claim 1, wherein
the processor is configured to change the view mode to hide the operation object from the display screen when a movement direction of the pointer is outside an angle range with respect to a line passing through the position of the pointer and circumscribing the operation object.

4. The information processing apparatus according to claim 1, wherein
the processor is configured to change the view mode to hide the operation object from the display screen when a component of a movement speed of the pointer is equal to or greater than a given value, the component being a component in a direction perpendicular to a direction from the pointer to the operation object.

5. The information processing apparatus according to claim 1, wherein
the processor is configured to change the view mode to hide the operation object from the display screen when a movement speed of the pointer is equal to or greater than a given value.

6. A method of controlling an information processing apparatus capable to be coupled to a display device with a display screen, comprising:
acquiring a position of a pointer displayed on the display screen, the pointer indicating operation position by a user of the information processing apparatus, and
changing, by a processor, a view mode of an operation object displayed on the display screen based on a transition in a position of the displayed pointer, the operation object being to be operated by the pointer.

7. The display control method according to claim 6, wherein
the changing changes the view mode to hide the operation object from the display screen when a movement direction of the pointer is outside a range defined based on a position of the operation object relative to the pointer.

8. The display control method according to claim 6, wherein
the changing changes the view mode to hide the operation object from the display screen when a movement direction of the pointer is outside an angle range with respect to a line passing through the position of the pointer and circumscribing the operation object.

9. The display control method according to claim 6, wherein
the changing changes the view mode to hide the operation object from the display screen when a component of a movement speed of the pointer is equal to or greater than a given value, the component being a component in a direction perpendicular to a direction from the pointer to the operation object.

10. The display control method according to claim 6, wherein
the changing changes the view mode to hide the operation object from the display screen when a movement speed of the pointer is equal to or greater than a given value.

11. A medium for storing a program that causes an information processing apparatus capable to be coupled to a display device with a display screen to execute a procedure comprising:
acquiring a position of a pointer displayed on the display screen, the pointer indicating operation position by a user of the information processing apparatus, and
changing, by a processor, a view mode of an operation object displayed on the display screen based on a transition in a position of the displayed pointer, the operation object being to be operated by the pointer.

12. The medium according to claim 11, wherein
the changing changes the view mode to hide the operation object from the display screen when a movement direction of the pointer is outside a range defined based on a position of the operation object relative to the pointer.

13. The medium according to claim 11, wherein
the changing changes the view mode to hide the operation object from the display screen when a movement direction of the pointer is outside an angle range with respect to a line passing through the position of the pointer and circumscribing the operation object.

14. The medium according to claim 11, wherein
the changing changes the view mode to hide the operation object from the display screen when a component of a movement speed of the pointer is equal to or greater than a given value, the component being a component in a direction perpendicular to a direction from the pointer to the operation object.

15. The medium according to claim 11, wherein
the changing changes the view mode to hide the operation object from the display screen when a movement speed of the pointer is equal to or greater than a given value.

16. A processing device to control displaying on a display device with a display screen, comprising:
a memory; and
a processor coupled to the memory to execute instructions stored in the memory to:
display an object selectable using a displayed pointer on the display screen; and
determine a condition to change view-ability of the selectable object on the display screen responsive to a transition in a position of the displayed pointer prior to a determination of a selection of the object.
